(19) United States
(12) Patent Application Publication
(10) Pub. No.: US 2016/0350250 A1
(43) Pub. Date: Dec. 1, 2016

(54) INPUT OUTPUT DATA ALIGNMENT

(71) Applicant: INTEL CORPORATION, Santa Clara, CA (US)

(72) Inventors: Anil Vasudevan, Portland, OR (US); Eric Geisler, Hillsboro, OR (US); Marshall Marc Millier, Banks, OR (US)

(73) Assignee: Intel Corporation, Santa Clara, CA (US)

(21) Appl. No.: 15/033,484

(22) PCT Filed: Dec. 23, 2013
(86) PCT No.: PCT/US2013/077577

§ 371 Date: Apr. 29, 2016

(51) Int. Cl. G06F 13/38; G06F 13/42

(52) U.S. Cl. CPC G06F 13/385; G06F 13/4282

(57) ABSTRACT

Techniques for handling unaligned data in a computing system are described herein. The techniques may include receiving data from an input/output (I/O) device, through an I/O interface. The data may be padded by adding values to the data at the I/O interface if the data is unaligned with respect to that computing system such that a consumer of the data associated with the I/O device ignores the added values.

### TECHNICAL FIELD

This disclosure relates generally to techniques for handling unaligned data. Specifically, this disclosure relates to handling unaligned data from an input/output device received at an input/output interface destined for a computing device.

### BACKGROUND ART

Computing devices may be configured to receive data from devices such as input/output (I/O) devices. I/O devices are devices that may communicate with a platform of the computing device including computing device processors, memory, and the like via I/O interfaces. I/O devices may include keyboards, mice, displays, network interface controllers (NICs), graphics processing units (GPUs) and the like. Data received from an I/O device may be destined for processing by a computing system. A computing device may optimize its memory hierarchy by implementing a structure that partitions data into uniformly sized segments or “lines”. Each “line” is a unit of the data available for processing by the computing device. The computing system may organize the data from an I/O device by aligning the address and size of the data segment with the structure of the lines. In some scenarios, data received from an I/O device may be destined for a buffer in the computing device memory. That memory may be optimized by a cache that provides high performance access to recently used segments of memory, known as cache lines. Data from the I/O device may not be on a cache line boundary or the data may not be an even multiple of the cache line size. This data is referred to as “unaligned” data. For example, data that is unaligned may include received data that is smaller than a given cache line size. Unaligned data received from an I/O device may increase latency of the computing device by requiring additional operations to be performed such as a read-modify-write operation to merge the new incoming data with that already in memory.

### BRIEF DESCRIPTION OF THE DRAWINGS

FIG. 1 is a block diagram illustrating a computing system including alignment logic;

FIG. 2 is a block diagram illustrating an I/O device connected to a system platform via an I/O interface including alignment logic;

FIG. 3 is a block diagram illustrating an I/O device connected to a system platform via an I/O interface including alignment indications in a packet header;

FIG. 4 is a block diagram illustrating a method for handling unaligned data; and

FIG. 5 is a block diagram illustrating an alternative method for handling unaligned data.

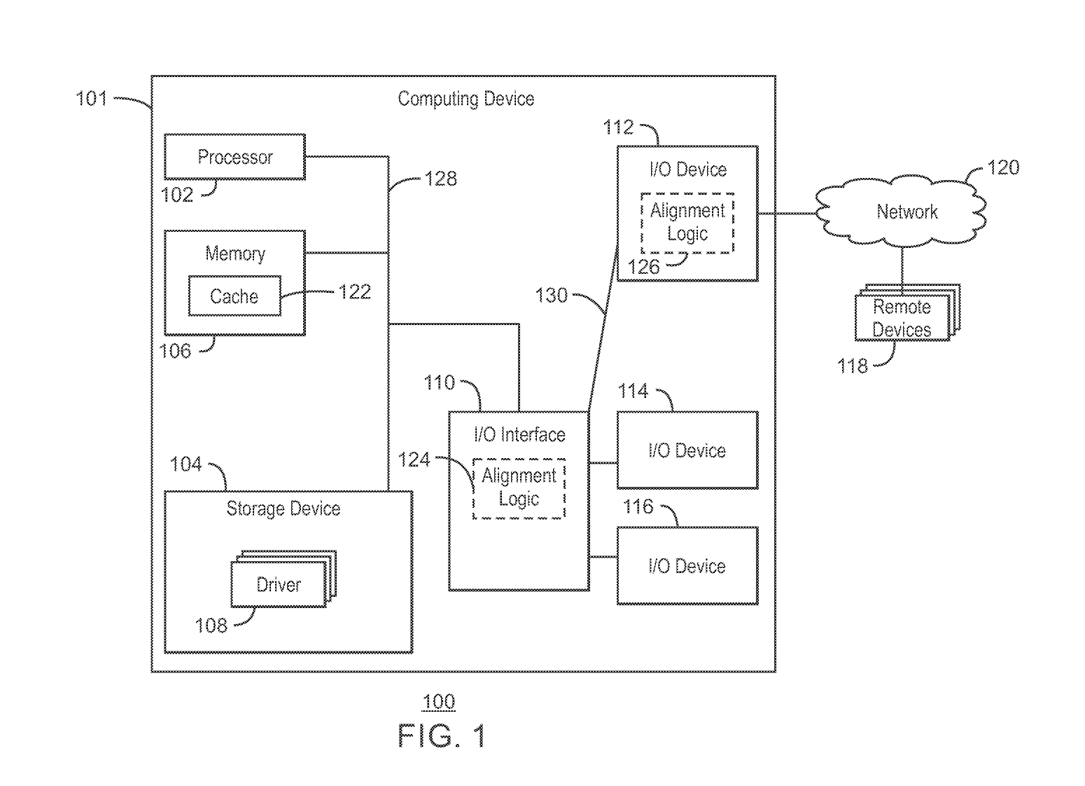

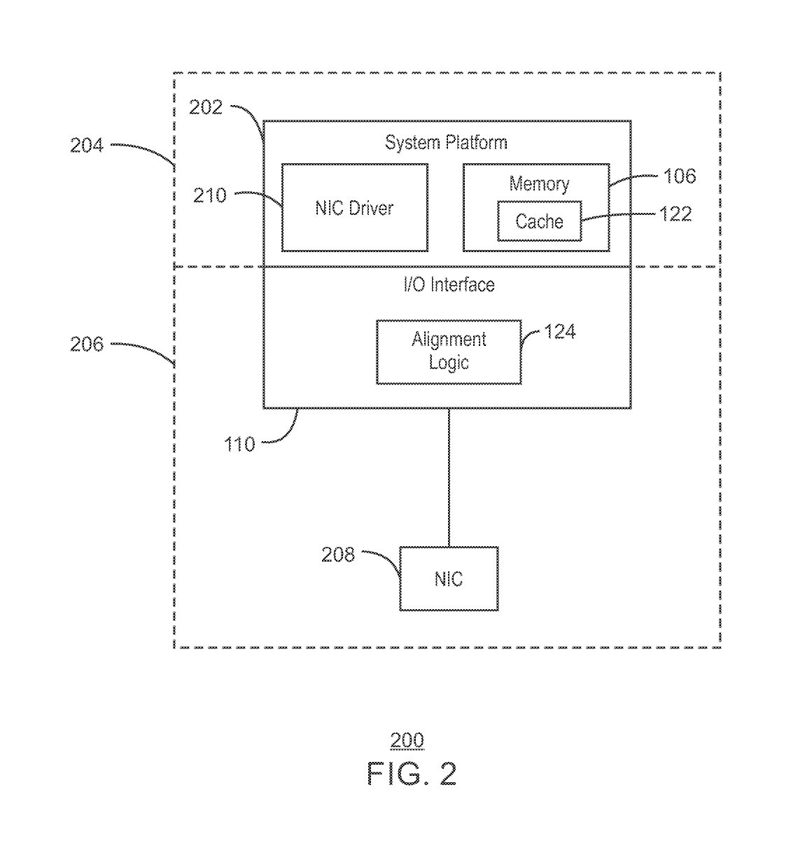

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

The present disclosure relates generally to techniques for handling unaligned data in a computing system. A computing system may receive data from various input/output (I/O) devices. For example, a network interface controller (NIC) receives data from a network and provide the data to a platform of the computing system including persistent memory units, processing units, and the like via an I/O interface. In some scenarios, the data from an I/O device is unaligned with respect to the computing system memory system when it is received at the I/O interface. For example, a computing system may receive data from an I/O device having cache line boundaries of 64 bytes. However, if data from the I/O device is 65 bytes long, the data must be written in two segments: a 64 byte full line request and a 1 byte partial line request. Unaligned data, as referred to herein, is data that that is not a full line request but is instead a partial line request based on a data alignment structure associated with a given computing system, such as a 64 byte data alignment structure of a cache line. Partial requests may require additional operations to be performed such as a read-modify-write (RMW) wherein the cache is required to merge a partial line request with memory within the computing system.

The techniques described herein receive data that is unaligned. Rather than performing a RMW, the techniques include padding the data by adding values to the data when it is unaligned. Software drivers associated with a given I/O device are configured to ignore the added values when reading the unaligned data in the cache, thereby avoiding RMW operations and any increase in latency associated with such operations. A service contract between the computing system including its device software and the I/O device allows the computing system to efficiently add and ignore padded data. The computing system is the consumer of the data transferred by the I/O device, wherein the I/O device is acting as the producer.

FIG. 1 is a block diagram illustrating a computing system including alignment logic. The computing system 100 includes a computing device 101 having a processor 102, a storage device 104 comprising a non-transitory computer-readable medium, and a memory device 106. The computing device 101 includes device drivers 108, an I/O interface 110, and I/O devices 112, 114, 116.

The I/O devices 112, 114, 116 may include a variety of devices configured to provide data to the I/O interface 110, such as a graphics device including a graphics processing unit, a disk drive, a network interface controller (NIC), and the like. In some embodiments, an I/O device, such as the I/O device 112 is connected to remote devices 118 via a network 120 as illustrated in FIG. 1.

The I/O devices 112, 114, 116 are configured to provide data to the I/O interface 110. As discussed above, the data provided from the I/O devices may be unaligned with a cache structure of the computing device 101. Cache alignment structure, as referred to herein, is the way data is arranged and accessed in the cache for the computer memory and may vary from system to system. Various types of cache alignment structures may include a 64 byte cache alignment structure, a 128 byte cache alignment structure, among other cache alignment structures. For example, the cache for memory device 106 of the computing device 101 may be configured with a 64 byte cache alignment structure. As illustrated in FIG. 1, the memory 106 includes a cache 122 having cache lines of a number of bytes long that are kept coherent with the data contained in the memory device 106.

In some embodiments, the I/O interface 110 includes alignment logic indicated by the dashed box 124 configured to handle unaligned data received from the I/O devices 112, 114, 116. In some embodiments, alignment logic 126 is disposed within the I/O devices, as indicated by the dashed box 126 of the I/O device 112, wherein the alignment logic 126 is to configure packets of data with instructions related to padding unaligned data to be performed at the I/O interface 110 as discussed in more detail below. In either embodiment, alignment logic, either 124 or 126, at least partially includes hardware logic to handle unaligned data. In some embodiments, the hardware logic is integrated circuitry configured to handle unaligned data received from an I/O device. In some embodiments, the alignment logic include other types of hardware logic such as program code executable by a processor, microcontroller, and the like, wherein the program code is stored in a non-transitory computer-readable medium. Handling of unaligned data includes padding unaligned data by adding values to the unaligned data such that the added values will be ignored by computing system components such as the drivers 108 while valid data within the padded data will be read by the computing system components. The I/O interface 110 may use routing features of an interconnect, indicated by 130 in FIG. 1, to classify data traffic from an I/O device which requires alignment. An interconnect, as referred to herein, is a communicative coupling defined for a wide variety of future computing and communication platforms, such as a Peripheral Component Interconnect Express (PCIe), or any other interconnect fabric technologies. In the techniques described herein, the interconnect 130 may classify data traffic by, for example, unique physical links, virtual channels, device IDs, or data stream IDs to indicate alignment logic should be performed at the I/O interface 110 on received data from the uniquely identified source. The I/O interface 110 can be configured with unique identifiers to identify when the service contract between the computing device 101 and the I/O device 112 is established.

The processor 102 of the computing device 101 may be a main processor that is adapted to execute the stored instructions. The processor 102 may be a single core processor, a multi-core processor, a computing cluster, or any number of other configurations. The processor 102 may be implemented as Complex Instruction Set Computer (CISC) or Reduced Instruction Set Computer (RISC) processors, x86 Instruction set compatible processors, multi-core, or any other microprocessor or central processing unit (CPU).

The memory device 106 can include random access memory (RAM) (e.g., static random access memory (SRAM), dynamic random access memory (DRAM), zero capacitor RAM, Silicon-Oxide-Nitride-Oxide-Silicon SONOS, embedded DRAM, extended data out RAM, double data rate (DDR) RAM, resistive random access memory (RRAM), parameter random access memory (PRAM), etc.), read only memory (ROM) (e.g., Mask ROM, programmable read only memory (PROM), erasable programmable read only memory (EPROM), electrically erasable programmable read only memory (EEPROM), etc.), flash memory, or any other suitable memory systems. The main processor 102 may be connected through a system bus 128 (e.g., Peripheral Component Interconnect (PCI), Industry Standard Architecture (ISA), PCI-Express, HyperTransport®, NuBus, etc.) to components including the memory 106, the storage device 104, the drivers 108, the I/O interface 110 and the I/O devices 112, 114, 116.

The block diagram of FIG. 1 is not intended to indicate that the computing device 101 is to include all of the components shown in FIG. 1. Further, the computing device 101 may include any number of additional components not shown in FIG. 1, depending on the details of the specific implementation.

FIG. 2 is a block diagram illustrating an I/O device connected to a system platform via an I/O interface including alignment logic. A system platform 202 may include memory units, storage devices, processors, system software including device drivers, and the like as discussed above in reference to FIG. 1. The system platform 202 is configured to use coherent memory operations through a memory cache 122. The dashed box 204 of FIG. 2 represents coherent memory space wherein data from memory is aligned according to a data alignment structure of the system platform 202. For discussion purposes, the system platform 202 in FIG. 2 is assumed to have a 64 byte data alignment structure although other data alignment structures may be implemented. The dashed box 206 represents the connection to an I/O interface, such as the I/O interface 110 of FIG. 1, associated with the system platform 202. The data transfers to or from the I/O device may be to or from addresses that are unaligned with respect to the platform memory cache 122.

As discussed above, the I/O interface 110 may receive unaligned data from an I/O device, such as the network interface controller (NIC) 208 illustrated in FIG. 2. Unaligned data from the NIC 208 may be received at the alignment logic 124 of the I/O interface 110. The I/O interface 110 may be configured to recognize a unique ID, such as a bus device function (BDF) of the I/O device, such as the NIC 208 in FIG. 2, such that before storing any unaligned data in the cache 122, the alignment logic 124 is instructed to pad the unaligned data by adding values to conform to the data alignment structure for the memory cache 122 in the system platform 202. In this example, the cache 122 includes cache lines having a 64 byte data alignment structure. Using a unique ID is one mechanism to register an I/O device with an I/O interface. Registering the I/O device, such as the NIC 208, with the I/O interface 110 is part of establishing the alignment service contract discussed above in reference to FIG. 1.

The padding of the unaligned data by the alignment logic 124 is such that the system software running on the computing platform, such as a NIC device driver 210 of FIG. 2, may be configured read the unaligned data and ignore the added values. In embodiments, a driver reads the unaligned data and ignores the added values based on a predefined agreement between the I/O interface 110 and the device driver, such as the NIC driver 210. For example, the NIC 208 may provide 65 bytes of data to the I/O interface 110. The first 64 bytes of data are stored in the cache 122 since the cache line is 64 bytes long according to the data alignment structure of the cache 122 in this example. The extra 1 byte of data is padded by the alignment logic with added values such as zeros to fill in 63 more bytes of data. The agreement between the NIC driver 210 and the I/O interface 110 enables the NIC driver 210 to read the first byte of data and ignore the 63 bytes of added values without requiring a RMW operation to be performed to synchronize the cache with memory 106.

It is noted that the alignment is not limited to cache line size. In embodiments, the alignment logic 124 pads data according to a largest acceptable alignment granularity for a given data alignment structure of a system platform such as cache line size granularity, page size granularity, and the like.

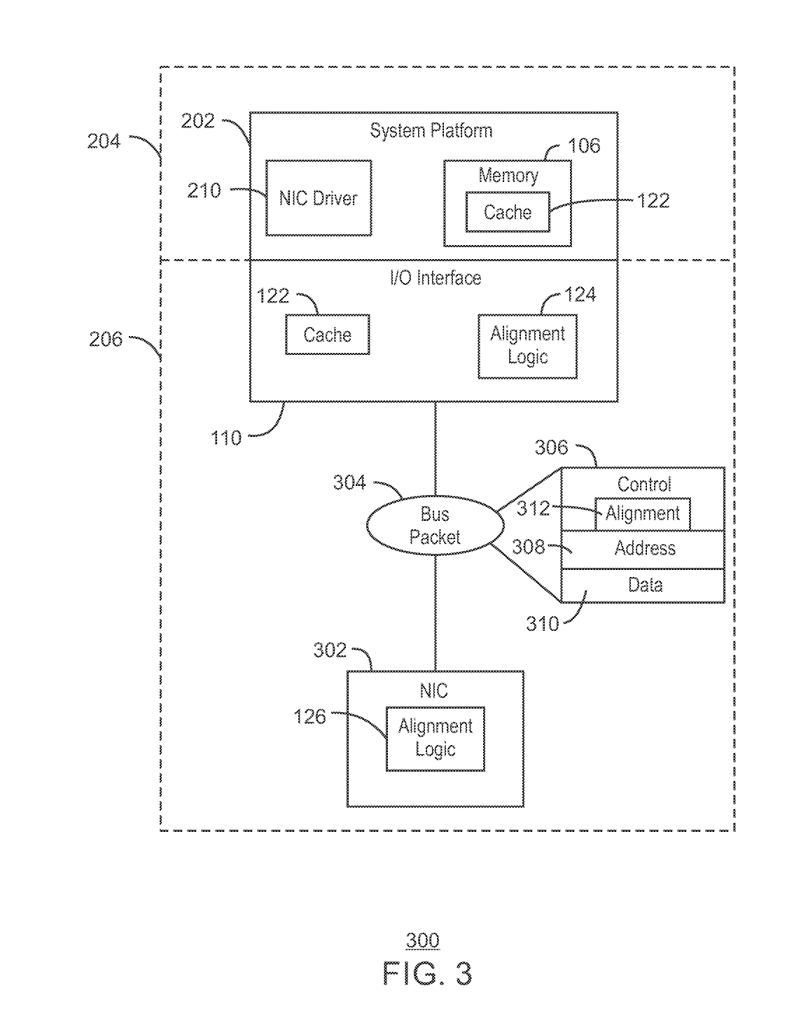

FIG. 3 is a block diagram illustrating an I/O device connected to a system platform via an I/O interface including alignment indications in a packet header. As discussed in reference to FIG. 2 above, the system platform 202 may be configured within the coherent memory space 204 having a 64 byte cache alignment structure although other data alignment structures may be implemented. The dashed box 206 illustrates the connection to an I/O interface, such as the I/O interface 110 of FIG. 1, associated with the system platform 202. The data transfers to or from the I/O device may be to or from addresses that are unaligned with respect to the platform memory cache 122.

In some embodiments, an I/O device, such as the NIC 302 illustrated in FIG. 3, provides alignment data within a header of a data packet 304. The packet 304 includes blocks such as a control header block 306, an address block 308, and a data block 310. Typically, packet headers include network headers identifying a valid length of the data without regard to alignment. In embodiments discussed herein, the control header block 306 includes alignment data 312, as illustrated in FIG. 3. In this embodiment, an I/O device, such as the NIC 302, includes alignment logic 126 configured to include the alignment data 312 within the control header block 306. The alignment data 312 indicates to the I/O interface 110 that the data packet 304 contains unaligned data such that the I/O interface 110 pads the data via the alignment logic 124. In this scenario the alignment data 312 is embedded within the data packet 304 such that the alignment data 312 is processed by the I/O interface 110 and infers padding can occur and the desired alignment. In some embodiments, the implementation of alignment data 312 within the packet 304 is processed at the I/O interface 110 without the alignment logic 124 by appropriate configuration of the I/O interface 110 to interpret the alignment data 312.

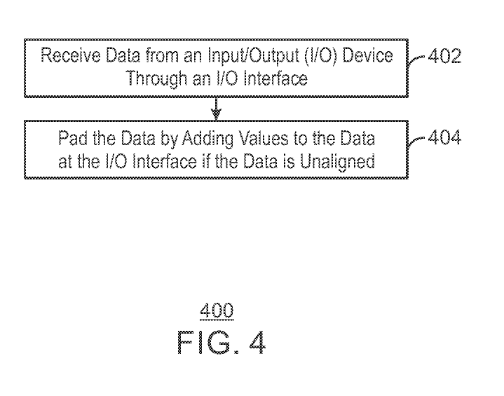

FIG. 4 is a block diagram illustrating a method for handling unaligned data. At block 402, data is received from an input/output (I/O) device at a cache of an I/O interface. Unaligned data is padded at block 404 such that a driver associated with the I/O device ignores the added values.

In some embodiments, the padding is performed without performing a RMW operation. In other words, rather than receiving unaligned data and performing a RMW for unaligned data, the I/O interface pads the data with values that are ignored by a driver associated with the I/O device as well as software of the computing system that accesses the padded data. In some embodiments the added values are ignored based on a contract established between the I/O device and the driver. The contract may be implemented as logic, at least partially comprising hardware logic, firmware, software or any combination thereof, such that valid bytes of unaligned data may be read when padded by the added values that are ignored. In some embodiments, the valid bytes of received data are indicated by a length field in a packet header provided from the I/O device.

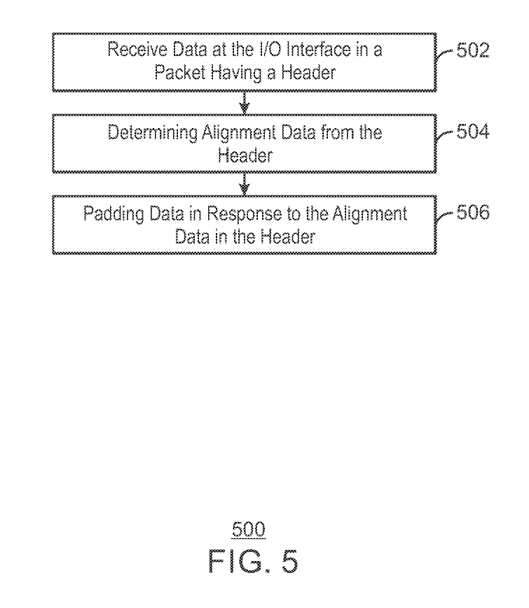

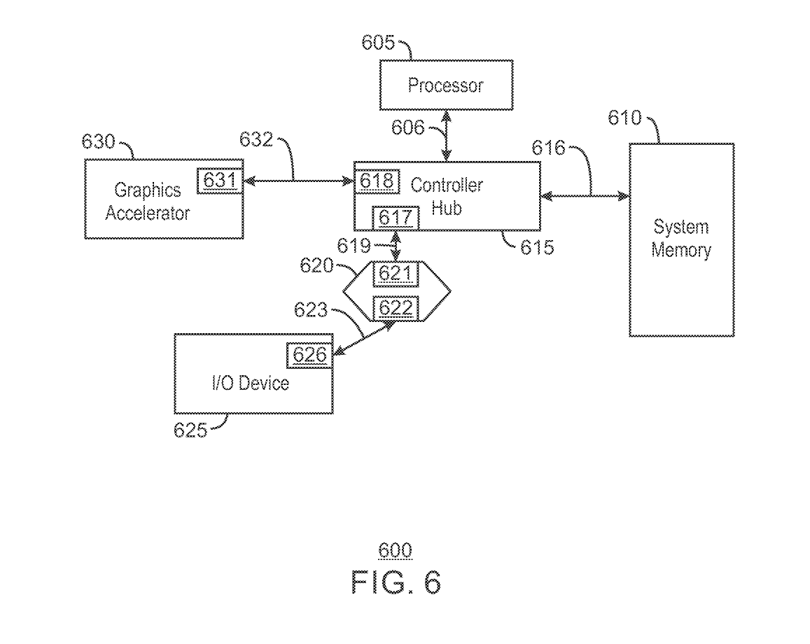

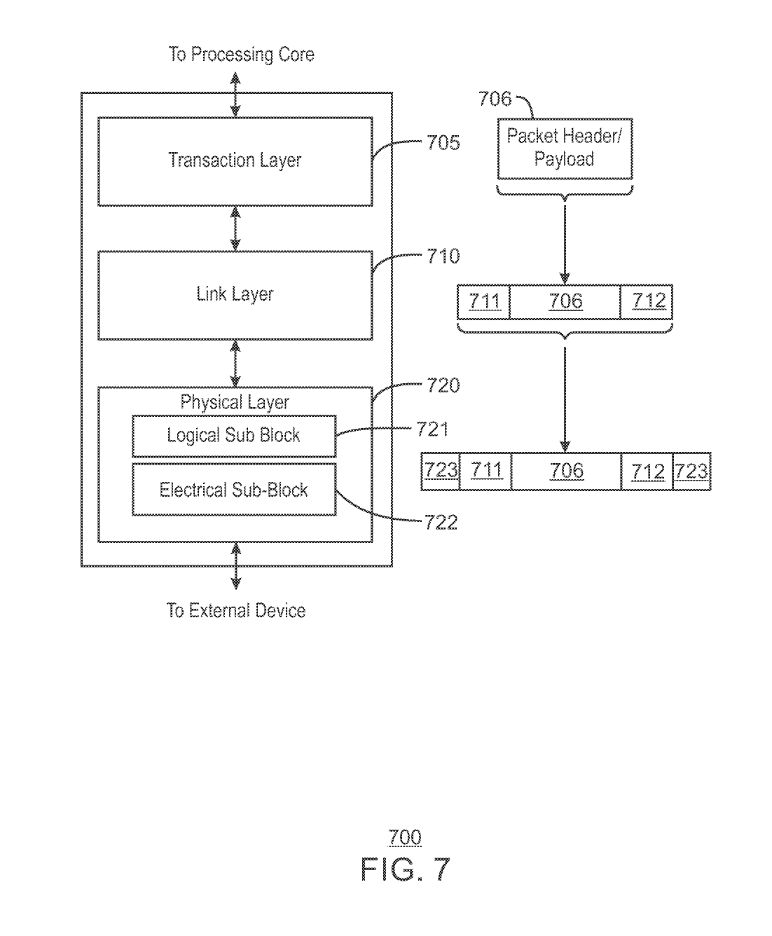

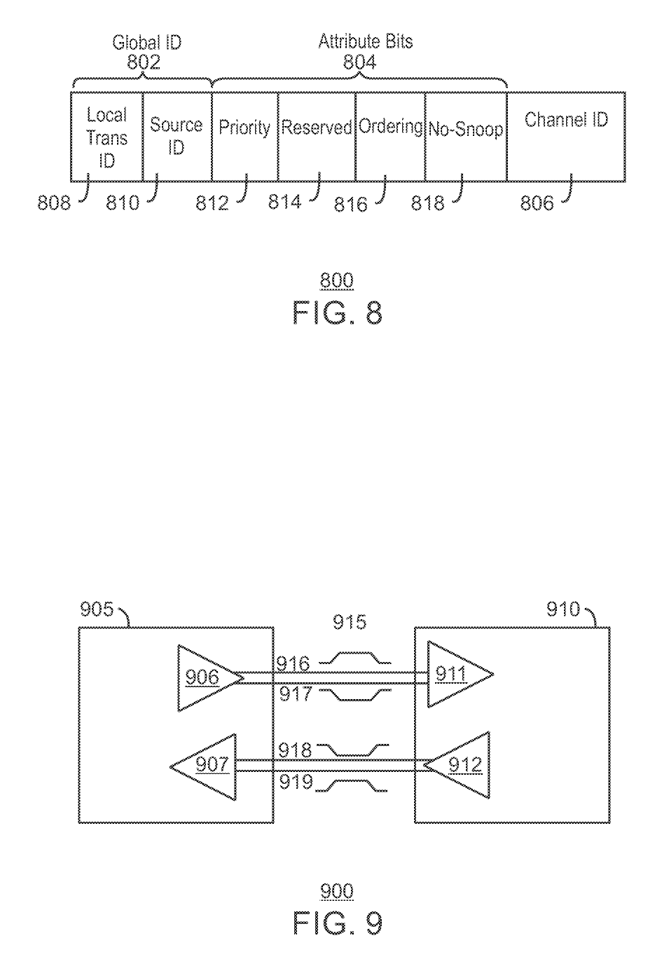

FIG. 5 is a block diagram illustrating an alternative method for handling unaligned data. As discussed above in regard to FIG. 3, in some embodiments, the data is received, at block 502 at the I/O interface through an interconnect that transfers data as a sequence of packets. Each packet is comprised of a header segment and a data segment. The header indicates, at block 504, that unaligned data is padded at the I/O interface such that padding is performed in response to the indication in the header, at block 506. In this embodiment, the packet header is configured at the I/O device before providing the packet to the I/O interface.

In the embodiments described herein, data is provided to or from the I/O interface to or from the I/O device via an interconnect fabric architecture. One interconnect fabric architecture includes the Peripheral Component Interconnect (PCI) Express (PCIe) architecture. A primary goal of PCIe is to enable components and devices from different vendors to inter-operate in an open architecture, spanning multiple market segments; Clients (Desktops and Mobile), Servers (Standard and Enterprise), and Embedded and Communication devices. PCI Express is a high performance, general purpose interconnect defined for a wide variety of future computing and communication platforms. Some PCI attributes, such as its usage model, load-store architecture, and software interfaces, have been maintained through its revisions, whereas previous parallel bus implementations have been replaced by a highly scalable, fully serial interface. The more recent versions of PCI Express take advantage of advances in point-to-point interconnects, Switch-based technology, and packetized protocol to deliver new levels of performance and features. Power Management, Quality Of Service (QoS), Hot-Plug/Hot-Swap support, Data Integrity, and Error Handling are among some of the advanced features supported by PCI Express.

Referring to FIG. 6, an embodiment of a fabric composed of point-to-point Links that interconnect a set of components is illustrated. System 600 includes processor 605 and system memory 610 coupled to controller hub 615. Processor 605 includes any processing element, such as a microprocessor, a host processor, an embedded processor, a co-processor, or other processor. Processor 605 is coupled to controller hub 615 through front-side bus (FSB) 606. In one embodiment, FSB 606 is a serial point-to-point interconnect as described below. In another embodiment, link 606 includes a serial, differential interconnect architecture that is compliant with different interconnect standard.

System memory 610 includes any memory device, such as random access memory (RAM), non-volatile (NV) memory, or other memory accessible by devices in system 600. System memory 610 is coupled to controller hub 615 through memory interface 616. Examples of a memory interface include a double-data rate (DDR) memory interface, a dual-channel DDR memory interface, and a dynamic RAM (DRAM) memory interface.

In one embodiment, controller hub 615 is a root hub, root complex, or root controller in a Peripheral Component Interconnect Express (PCIe or PCIE) interconnection hierarchy. Examples of controller hub 615 include a chipset, a memory controller hub (MCH), a northbridge, an interconnect controller hub (ICH) a southbridge, and a root controller/hub. Often the term chipset refers to two physically separate controller hubs, i.e. a memory controller hub (MCH) coupled to an interconnect controller hub (ICH). Note that current systems often include the MCH integrated with processor 605, while controller 615 is to communicate with I/O devices, in a similar manner as described below. In some embodiments, peer-to-peer routing is optionally supported through root complex 615.

Here, controller hub 615 is coupled to switch/bridge 620 through serial link 619. Input/output modules 617 and 621, which may also be referred to as interfaces/ports 617 and 621, include/implement a layered protocol stack to provide communication between controller hub 615 and switch 620. In one embodiment, multiple devices are capable of being coupled to switch 620.

Switch/bridge 620 routes packets/messages from device 625 upstream, i.e. up a hierarchy towards a root complex, to controller hub 615 and downstream, i.e. down a hierarchy away from a root controller, from processor 605 or system memory 610 to device 625. Switch 620, in one embodiment, is referred to as a logical assembly of multiple virtual PCI-to-PCI bridge devices. Device 625 includes any internal or external device or component to be coupled to an electronic system, such as an I/O device, a Network Interface Controller (NIC), an add-in card, an audio processor, a network processor, a hard-drive, a storage device, a CD/DVD ROM, a monitor, a printer, a mouse, a keyboard, a router, a portable storage device, a Firewire device, a Universal Serial Bus (USB) device, a scanner, and other input/output devices. Often in the PCIe vernacular, such as device, is referred to as an endpoint. Although not specifically shown, device 625 may include a PCIe to PCI/PCI-X bridge to support legacy or other version PCI devices. Endpoint devices in PCIe are often classified as legacy, PCIe, or root complex integrated endpoints.

Graphics accelerator 630 is also coupled to controller hub 615 through serial link 632. In one embodiment, graphics accelerator 630 is coupled to an MCH, which is coupled to an ICH. Switch 620, and accordingly I/O device 625, is then coupled to the ICH. I/O modules 631 and 618 are also to implement a layered protocol stack to communicate between graphics accelerator 630 and controller hub 615. Similar to the MCH discussion above, a graphics controller or the graphics accelerator 630 itself may be integrated in processor 605.

Turning to FIG. 7 an embodiment of a layered protocol stack is illustrated. Layered protocol stack 700 includes any form of a layered communication stack, such as a Quick Path Interconnect (QPI) stack, a PCIe stack, a next generation high performance computing interconnect stack, or other layered stack. Although the discussion immediately below in reference to FIGS. 6-9 are in relation to a PCIe stack, the same concepts may be applied to other interconnect stacks. In one embodiment, protocol stack 700 is a PCIe protocol stack including transaction layer 705, link layer 710, and physical layer 720. An interface, such as interfaces 617, 618, 621, 622, 626, and 631 in FIG. 6, may be represented as communication protocol stack 700. Representation as a communication protocol stack may also be referred to as a module or interface implementing/including a protocol stack.

PCI Express uses packets to communicate information between components. Packets are formed in the Transaction Layer 705 and Data Link Layer 710 to carry the information from the transmitting component to the receiving component. As the transmitted packets flow through the other layers, they are extended with additional information necessary to handle packets at those layers. At the receiving side the reverse process occurs and packets get transformed from their Physical Layer 720 representation to the Data Link Layer 710 representation and finally (for Transaction Layer Packets) to the form that can be processed by the Transaction Layer 705 of the receiving device.

Transaction Layer

In one embodiment, transaction layer 705 is to provide an interface between a device's processing core and the interconnect architecture, such as data link layer 710 and physical layer 720. In this regard, a primary responsibility of the transaction layer 705 is the assembly and disassembly of packets (i.e., transaction layer packets, or TLPs). The translation layer 705 typically manages credit-base flow control for TLPs. PCIe implements split transactions, i.e. transactions with request and response separated by time, allowing a link to carry other traffic while the target device gathers data for the response.

In addition PCIe utilizes credit-based flow control. In this scheme, a device advertises an initial amount of credit for each of the receive buffers in Transaction Layer 705. An external device at the opposite end of the link, such as controller hub 615 in FIG. 6, counts the number of credits consumed by each TLP. A transaction may be transmitted if the transaction does not exceed a credit limit. Upon receiving a response an amount of credit is restored. An advantage of a credit scheme is that the latency of credit return does not affect performance, provided that the credit limit is not encountered.

In one embodiment, four transaction address spaces include a configuration address space, a memory address space, an input/output address space, and a message address space. Memory space transactions include one or more of read requests and write requests to transfer data to/from a memory-mapped location. In one embodiment, memory space transactions are capable of using two different address formats, e.g., a short address format, such as a 32-bit address, or a long address format, such as 64-bit address. Configuration space transactions are used to access configuration space of the PCIe devices. Transactions to the configuration space include read requests and write requests. Message space transactions (or, simply messages) are defined to support in-band communication between PCIe agents.

Therefore, in one embodiment, transaction layer 705 assembles packet header/payload 706. Format for current packet headers/payloads may be found in the PCIe specification at the PCIe specification website. As discussed above, in one embodiment, the packet header is configured with configuration instructions such that the data within the packet is unaligned and is padded at the I/O interface.

Quickly referring to FIG. 8, an embodiment of a PCIe transaction descriptor is illustrated. In one embodiment, transaction descriptor 800 is a mechanism for carrying transaction information. In this regard, transaction descriptor 800 supports identification of transactions in a system. Other potential uses include tracking modifications of default transaction ordering and association of transaction with channels.

Transaction descriptor 800 includes global identifier field 802, attributes field 804 and channel identifier field 806. In the illustrated example, global identifier field 802 is depicted comprising local transaction identifier field 808 and source identifier field 810. In one embodiment, global transaction identifier 802 is unique for all outstanding requests.

According to one implementation, local transaction identifier field 808 is a field generated by a requesting agent, and it is unique for all outstanding requests that require a completion for that requesting agent. Furthermore, in this example, source identifier 810 uniquely identifies the requestor agent within a PCIe hierarchy. Accordingly, together with source ID 810, local transaction identifier 808 field provides global identification of a transaction within a hierarchy domain.

Attributes field 804 specifies characteristics and relationships of the transaction. In this regard, attributes field 804 is potentially used to provide additional information that allows modification of the default handling of transactions. In one embodiment, attributes field 804 includes priority field 812, reserved field 814, ordering field 816, and no-snoop field 818. Here, priority sub-field 812 may be modified by an initiator to assign a priority to the transaction. Reserved attribute field 814 is left reserved for future, or vendor-defined usage. Possible usage models using priority or security attributes may be implemented using the reserved attribute field.

In this example, ordering attribute field 816 is used to supply optional information conveying the type of ordering that may modify default ordering rules. According to one example implementation, an ordering attribute of “0” denotes default ordering rules are to apply, wherein an ordering attribute of “1” denotes relaxed ordering, wherein writes can pass writes in the same direction, and read completions can pass writes in the same direction. Snoop attribute field 818 is utilized to determine if transactions are snooped. As shown, channel ID Field 806 identifies a channel that a transaction is associated with.

Link Layer

Link layer 710, also referred to as data link layer 710, acts as an intermediate stage between transaction layer 705 and the physical layer 720. In one embodiment, a responsibility of the data link layer 710 is providing a reliable mechanism for exchanging Transaction Layer Packets (TLPs) between two components a link. One side of the Data Link Layer 710 accepts TLPs assembled by the Transaction Layer 705, applies packet sequence identifier 711, i.e. an identification number or packet number, calculates and applies an error detection code, i.e. CRC 712, and submits the modified TLPs to the Physical Layer 720 for transmission across a physical to an external device.

Physical Layer

In one embodiment, physical layer 720 includes logical sub block 721 and electrical sub-block 722 to physically transmit a packet to an external device. Here, logical sub-block 721 is responsible for the “digital” functions of Physical Layer 721. In this regard, the logical sub-block includes a transmit section to prepare outgoing information for transmission by physical sub-block 722, and a receiver section to identify and prepare received information before passing it to the Link Layer 710.

Physical block 722 includes a transmitter and a receiver. The transmitter is supplied by logical sub-block 721 with symbols, which the transmitter serializes and transmits onto to an external device. The receiver is supplied with serialized symbols from an external device and transforms the received signals into a bit-stream. The bit-stream is de-serialized and supplied to logical sub-block 721. In one embodiment, an 8b/10b transmission code is employed, where ten-bit symbols are transmitted/received. Here, special symbols are used to frame a packet with frames 723. In addition, in one example, the receiver also provides a symbol clock recovered from the incoming serial stream.

As stated above, although transaction layer 705, link layer 710, and physical layer 720 are discussed in reference to a specific embodiment of a PCIe protocol stack, a layered protocol stack is not so limited. In fact, any layered protocol may be included/implemented. As an example, a port/interface that is represented as a layered protocol includes: (1) a first layer to assemble packets, i.e. a transaction layer; a second layer to sequence packets, i.e. a link layer; and a third layer to transmit the packets, i.e. a physical layer. As a specific example, a common standard interface (CSI) layered protocol is utilized.

Referring next to FIG. 9, an embodiment of a PCIe serial point to point fabric is illustrated. Although an embodiment of a PCIe serial point-to-point link is illustrated, a serial point-to-point link is not so limited, as it includes any transmission path for transmitting serial data. In the embodiment shown, a basic PCIe link includes two, low-voltage, differentially driven signal pairs: a transmit pair 906/911 and a receive pair 912/907. Accordingly, device 905 includes transmission logic 906 to transmit data to device 910 and receiving logic 907 to receive data from device 910. In other words, two transmitting paths, i.e. paths 916 and 917, and two receiving paths, i.e. paths 918 and 919, are included in a PCIe link.

A transmission path refers to any path for transmitting data, such as a transmission line, a copper line, an optical line, a wireless communication channel, an infrared communication link, or other communication path. A connection between two devices, such as device 905 and device 910, is referred to as a link, such as link 415. A link may support one lane—each lane representing a set of differential signal pairs (one pair for transmission, one pair for reception). To scale bandwidth, a link may aggregate multiple lanes denoted by ×N, where N is any supported Link width, such as 1, 2, 4, 8, 12, 16, 32, 64, or wider.

A differential pair refers to two transmission paths, such as lines 416 and 417, to transmit differential signals. As an example, when line 416 toggles from a low voltage level to a high voltage level, i.e. a rising edge, line 417 drives from a high logic level to a low logic level, i.e. a falling edge. Differential signals potentially demonstrate better electrical characteristics, such as better signal integrity, i.e. cross-coupling, voltage overshoot/undershoot, ringing, etc. This allows for better timing window, which enables faster transmission frequencies.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

1-25. (canceled)

26. A method of processing unaligned data in a computing system, comprising:
receiving data from an input/output (I/O) device through an I/O interface; and
padding the data by adding values to the data at the I/O interface if the data is unaligned such that a consumer of the data associated with the I/O device ignores the added values.

27. The method of claim 26, wherein the padding is performed without performing a read-modify-write operation for the unaligned data.

28. The method of claim 26, wherein the data is received at the I/O interface in a packet comprising a header, the method comprising indicating in the header that unaligned data may be padded at the I/O interface, wherein the padding is performed in response to the indication in the header.

29. The method of claim 28, wherein the packet header is configured at the I/O device to indicate that unaligned data may be padded.

30. The method of claim 26, wherein the consumer ignores the added values based on a predefined contract between the consumer and the I/O interface.

31. The method of claim 26, comprising determining valid bytes of the received data based on a length field in the data.

32. The method of claim 26, wherein the cache is associated with an alignment granularity, the alignment granularity comprising:
cache line boundary granularity;
page boundary granularity;
a configurable granularity; or
any combination thereof.

33. A system, comprising:
an input/output (I/O) interface to receive data from an I/O device; and
logic, at least partially comprising hardware logic of the I/O interface, to:
pad the data by adding values to the data at the I/O interface if the data is unaligned such that a consumer of the data associated with the I/O device ignores the added values.

34. The system of claim 33, wherein the padding is performed without performing a read-modify-write operation for the unaligned data.

35. The system of claim 33, wherein the data is received at the I/O interface in a packet comprising a header, the system comprising logic of the I/O device, at least partially comprising hardware logic, wherein the logic is to indicate in the header that unaligned data may be padded at the I/O interface, and wherein the padding is performed in response to the indication in the header.

36. The system of claim 35, wherein the packet header is configured at the I/O device to indicate that unaligned data may be padded.

37. The system of claim 33, wherein the consumer ignores the added values based on a predefined contract between the consumer and the I/O interface.

38. The system of claim 33, wherein the driver determines valid bytes of the received data based on a length field in the data.

39. The system of claim 33, wherein the cache is associated with an alignment granularity, the alignment granularity comprising:
cache line boundary granularity;
page boundary granularity;
a configurable granularity; or
any combination thereof.

40. A computing device, comprising:
an input/output (I/O) interface to receive unaligned data from an I/O device;
logic, at least partially comprising hardware logic of the I/O interface, to add values to the unaligned data at the I/O interface such that a consumer of the data associated with the I/O device ignores the added values.

41. The computing device of claim 40, wherein the I/O device is to transfer data to the computing device for processing.

42. The computing device of claim 40, wherein the values are added without performing a read-modify-write operation for the unaligned data.

43. The computing device of claim 40, comprising I/O device logic, at least partially comprising hardware logic, to:
provide data packets to the I/O interface; and
indicate in a header of the data packet unaligned data to be padded at the I/O interface, wherein the values are added in response to the indication in the header.

44. The computing device of claim 40, wherein the consumer ignores the added values based on a predefined contract between the consumer and the I/O interface.

45. The computing device of claim 40, wherein the driver determines valid bytes of the received data based on a length field in a header.

46. The computing device of claim 40, wherein the cache is associated with an alignment granularity, the alignment granularity comprising:
cache line boundary granularity;
page boundary granularity;
a configurable granularity; or
any combination thereof.
